(19) United States
(12) Patent Application Publication
(10) Pub. No.: US 2025/0200422 A1
(43) Pub. Date: Jun. 19, 2025

(54) POST-HOC UNCERTAINTY QUANTIFICATION FOR MACHINE LEARNING SYSTEMS

(71) Applicants: International Business Machines Corporation, Armonk, NY (US); Massachusetts Institute of Technology, Cambridge, MA (US)

(72) Inventors: Maohao Shen, Cambridge, MA (US); Yuheng Bu, Philadelphia, PA (US); Prasanna Sattigeri, Acton, MA (US); Soumya Ghosh, Boston, MA (US); Subhro Das, Cambridge, MA (US); Gregory Wornell, Wellesley, MA (US)

(21) Appl. No.: 18/538,726

(22) Filed: Dec. 13, 2023

(51) Int. Cl. G06N 20/00

(52) U.S. Cl. CPC G06N 20/00

(57) ABSTRACT

A pretrained machine learning model is obtained. A Bayesian meta-model is configured to cooperate with the pretrained machine learning model, the Bayesian meta-model being configured to quantify different kinds of uncertainties associated with the pretrained machine learning model, wherein the Bayesian meta-model comprises a plurality of linear layers attached to different intermediate features of the pretrained machine learning model with a final linear layer generating a Dirichlet distribution. Multiple intermediate features extracted from the pretrained machine learning model are received as inputs. A Dirichlet distribution is generated over a probability simplex as output, wherein the Dirichlet distribution is parameterized by the Bayesian meta-model and allows quantification of uncertainty of model prediction, and the Bayesian meta-model and the pretrained machine learning model are used in a downstream task.

The following disclosure(s) are submitted under 35 U.S.C. 102(b)(1)(A):
Maohao Shen, Yuheng Bu, Prasanna Sattigeri, Soumya Ghosh, Subhro Das, and Gregory Wornell, “Post-hoc uncertainty learning using a Dirichlet meta-model,” in Proceedings of the AAAI Conference on Artificial Intelligence 2023 Jun. 26 (Vol. 37, No. 8, pp. 9772-9781).
Maohao Shen, Yuheng Bu, Prasanna Sattigeri, Soumya Ghosh, Subhro Das, and Gregory Wornell, “Post-hoc Uncertainty Learning using a Dirichlet Meta-Model,” arXiv: 2212.07359v1, 14 Dec. 2022.

### BACKGROUND

The present invention relates generally to the electrical, electronic and computer arts and, more particularly, to machine learning.

Neural networks are known to have a problem of being over-confident when directly using an output label distribution to generate uncertainty measures. Existing methods mainly resolve this issue by retraining the entire machine learning model to impose the uncertainty quantification capability so that the learned model can achieve the desired performance in accuracy and uncertainty prediction simultaneously. However, training the model from scratch is computationally expensive and may not be feasible in many situations.

Despite the promising performance of deep neural networks achieved in various practical tasks, uncertainty quantification (UQ) has attracted growing attention in recent years to fulfill the emerging demand for more robust and reliable machine learning models, as UQ aims to measure the reliability of the model's prediction quantitatively, and the transparency of machine learning models by quantitively measuring the uncertainty of the model's predictions: generating low uncertainty when the prediction is correct and high uncertainty when the prediction is wrong. Accurate uncertainty estimation is particularly significant for fields that are highly sensitive to error prediction, such as autonomous driving, financial services, and medical diagnosis. Accurate uncertainty quantification can prevent machine learning models from taking the risk of making wrong predictions by letting humans become involved in the decision-making process.

As alluded to above, existing uncertainty quantification solutions are computationally heavy, requiring the training of a model from scratch to achieve the desired prediction and uncertainty quantification performance simultaneously, and sometimes require training multiple models or inferencing the model multiple times. Conventional solutions often suffer from a lack of flexibility, cannot quantify different uncertainties (such as total, aleatoric, and epistemic uncertainties) and require specific training objectives or model architectures.

### BRIEF SUMMARY

Principles of the invention provide systems and techniques for post-hoc uncertainty quantification for machine learning systems. In one aspect, an exemplary method includes the operations of obtaining a pretrained machine learning model; configuring a Bayesian meta-model to cooperate with the pretrained machine learning model, the Bayesian meta-model being configured to quantify different kinds of uncertainties associated with the pretrained machine learning model, wherein the Bayesian meta-model comprises a plurality of linear layers attached to different intermediate features of the pretrained machine learning model with a final linear layer generating a Dirichlet distribution; receiving multiple intermediate features extracted from the pretrained machine learning model as inputs; generating a Dirichlet distribution over a probability simplex as output, wherein the Dirichlet distribution is parameterized by the Bayesian meta-model and allows quantification of uncertainty of model prediction; and using the Bayesian meta-model and the pretrained machine learning model in a downstream task.

In one aspect, a computer program product comprises one or more tangible computer-readable storage media and program instructions stored on at least one of the one or more tangible computer-readable storage media, the program instructions executable by a processor, the program instructions comprising obtaining a pretrained machine learning model; configuring a Bayesian meta-model to cooperate with the pretrained machine learning model, the Bayesian meta-model being configured to quantify different kinds of uncertainties associated with the pretrained machine learning model, wherein the Bayesian meta-model comprises a plurality of linear layers attached to different intermediate features of the pretrained machine learning model with a final linear layer generating a Dirichlet distribution; receiving multiple intermediate features extracted from the pretrained machine learning model as inputs; generating a Dirichlet distribution over a probability simplex as output, wherein the Dirichlet distribution is parameterized by the Bayesian meta-model and allows quantification of uncertainty of model prediction; and using the Bayesian meta-model and the pretrained machine learning model in a downstream task.

In one aspect, an apparatus comprises a memory and at least one processor, coupled to the memory, and operative to perform operations comprising obtaining a pretrained machine learning model; configuring a Bayesian meta-model to cooperate with the pretrained machine learning model, the Bayesian meta-model being configured to quantify different kinds of uncertainties associated with the pretrained machine learning model, wherein the Bayesian meta-model comprises a plurality of linear layers attached to different intermediate features of the pretrained machine learning model with a final linear layer generating a Dirichlet distribution; receiving multiple intermediate features extracted from the pretrained machine learning model as inputs; generating a Dirichlet distribution over a probability simplex as output, wherein the Dirichlet distribution is parameterized by the Bayesian meta-model and allows quantification of uncertainty of model prediction; and using the Bayesian meta-model and the pretrained machine learning model in a downstream task.

As used herein, “facilitating” an action includes performing the action, making the action easier, helping to carry the action out, or causing the action to be performed. Thus, by way of example and not limitation, instructions executing on a processor might facilitate an action carried out by instructions executing on a remote processor, by sending appropriate data or commands to cause or aid the action to be performed. Where an actor facilitates an action by other than performing the action, the action is nevertheless performed by some entity or combination of entities.

Techniques as disclosed herein can provide substantial beneficial technical effects. Some embodiments may not have these potential advantages and these potential advantages are not necessarily required of all embodiments. By way of example only and without limitation, one or more embodiments may provide one or more of:
improvements to the technological process of machine learning by eliminating the need for additional training data and eliminating the need to modify the base model;
enhanced computational efficiency since the disclosed meta-model is simpler than the base model; and
improvements to the technological process of machine learning by utilizing UQ techniques that are flexible enough to quantify different uncertainties for different down-stream tasks and easy to adapt to different application settings, including out-of-domain data detection, misclassification detection, and trustworthy transfer learning.

These and other features and advantages will become apparent from the following detailed description of illustrative embodiments thereof, which is to be read in connection with the accompanying drawings.

### BRIEF DESCRIPTION OF THE DRAWINGS

The following drawings are presented by way of example only and without limitation, wherein like reference numerals (when used) indicate corresponding elements throughout the several views, and wherein:

FIG. 1 illustrates a “toy” example (i.e., an expository example helpful for test and demonstration) of an exemplary meta-model method in an Out-of-Distribution (OOD) detection application that shows the diversity of features in different layers, in accordance with an example embodiment;

FIG. 2 illustrates the overall structure of the meta-model, in accordance with an example embodiment;

FIG. 3A is a table of the OOD detection results for three benchmark datasets, in accordance with an example embodiment;

FIG. 3B is a table of the misclassification detection results for the three bench-mark datasets, the first conventional large database of handwritten digits, the first conventional image dataset, and the second conventional image dataset, in accordance with an example embodiment;

FIG. 3C is a table of Trustworthy Transfer Learning Results, in accordance with an example embodiment;

FIG. 3D is a table of an Ablation Study of Meta-model (“Linear-Meta”), in accordance with an example embodiment;

FIG. 4A is a table summarizing the hyperparameters for training the base model and meta-model and a table summarizing the hyperparameters for training the meta-model, in accordance with an example embodiment;

FIGS. 4B and 4C are tables showing the results for an OOD detection area under the receiver operating characteristic (ROC) curve (AUROC), in accordance with an example embodiment;

FIG. 4D is a table showing a comparison of the misclassification results, in accordance with an example embodiment;

FIG. 4E is a table showing the complete results of an ablation study, in accordance with an example embodiment; and

FIG. 5 depicts a computing environment according to an embodiment of the present invention.

It is to be appreciated that elements in the figures are illustrated for simplicity and clarity. Common but well-understood elements that may be useful or necessary in a commercially feasible embodiment may not be shown in order to facilitate a less hindered view of the illustrated embodiments.

### DETAILED DESCRIPTION

Principles of inventions described herein will be in the context of illustrative embodiments. Moreover, it will become apparent to those skilled in the art given the teachings herein that numerous modifications can be made to the embodiments shown that are within the scope of the claims. That is, no limitations with respect to the embodiments shown and described herein are intended or should be inferred.

Most state-of-the-art approaches to uncertainty quantification focus on building a deep model equipped with uncertainty quantification capability so that a single deep model can achieve both the desired prediction and UQ performance simultaneously. However, such an approach for UQ suffers from practical limitations because it either requires a specific model structure or explicitly training the entire model from scratch to impose the uncertainty quantification ability. A more realistic scenario is to quantify the uncertainty of a pretrained model in a post-hoc manner due to practical constraints. For example, (1) compared with prediction accuracy and generalization performance, the uncertainty quantification ability of deep learning models is usually considered with lower priority, especially for profit-oriented applications, such as recommendation systems; (2) some applications require the models to impose other constraints, such as fairness or privacy, which might sacrifice the UQ performance; and (3) for some applications such as transfer learning, the pretrained models are usually available, and it might be a waste of resources to train a new model from scratch.

Motivated by these practical concerns, one pertinent focus of one or more embodiments is on tackling the post-hoc uncertainty learning problem; i.e., given a pretrained model, determine how to improve its UQ quality without affecting its predictive performance. Prior works on improving uncertainty quality in a post-hoc setting have mainly been targeted towards improving calibration. These approaches typically fail to augment the pre-trained model with the ability to capture different sources of uncertainty, such as epistemic uncertainty, which is pertinent for applications such as Out-of-Distribution (OOD) detection. Several recent works have adopted the meta-modeling approach, where a meta-model is trained to predict whether or not the pretrained model is correct on the validation samples. These methods still rely on a point estimate of the meta-model parameters, which can be unreliable, especially when the validation set is small.

In one example embodiment, a more practical post-hoc uncertainty learning setting is considered, where a well-trained base model is given, and the uncertainty quantification task is focused on the second stage of training. In one example embodiment, a Bayesian meta-model is disclosed to augment pre-trained models with better uncertainty quantification abilities, which is effective and computationally efficient. The disclosed methods require no additional training data (no modification of the base model), are flexible enough to quantify different uncertainties for different down-stream tasks and easily adapt to different application settings, including out-of-domain data detection, misclassification detection, and trustworthy transfer learning. An exemplary meta-model approach's flexibility and superior empirical performance are demonstrated on these applications over multiple representative image classification benchmarks. Exemplary techniques are flexible enough to quantify different kinds of uncertainties and easily adapt to different application settings.

Exemplary empirical results provide pertinent insights regarding meta-model training: (1) the diversity in feature representations across different layers is important for uncertainty quantification, especially for out-of-domain (OOD) data detection tasks; (2) leveraging the Dirichlet meta-model to capture different uncertainties, including total uncertainty and epistemic uncertainty; and (3) there exists an over-fitting issue in uncertainty learning similar to supervised learning that should be addressed by a novel validation strategy to achieve better performance. Furthermore, it is shown that exemplary embodiments have the flexibility to adapt to various applications, including OOD detection, misclassification detection, and trustworthy transfer learning.

Uncertainty Quantification methods can be broadly classified as intrinsic or extrinsic, depending on how the uncertainties are obtained from the machine learning models. Intrinsic methods encompass models that inherently provide an uncertainty estimate along with their predictions. Some intrinsic methods, such as neural networks with homoscedastic/heteroscedastic noise models and quantile regression, can only capture Data (aleatoric) uncertainty. Many applications including out-of-distribution detection, require capturing both Data (aleatoric) and Model (epistemic) accurately. Bayesian methods such as Bayesian neural networks (BNNs) and Gaussian processes and ensemble methods are well-known examples of intrinsic methods that can quantify both uncertainties. However, Bayesian methods and ensembles can be quite expensive and require several approximations to learn/optimize in practice.

Under model misspecification, Bayesian approaches are not well-calibrated and can produce severely mis-calibrated uncertainties.

For models without an inherent notion of uncertainty, extrinsic methods are employed to extract uncertainties in a post-hoc manner. However, many conventional methods require additional data samples that are either validation or out of distribution dataset to train or tune the hyper-parameter, which is infeasible when these data are not available. Moreover, they are often not flexible enough to distinguish epistemic uncertainty and aleatoric uncertainty, which are known to be significant in various learning applications. In contrast, exemplary embodiments do not require additional training data or modifying the training procedure of the base model.

### Problem Formulation

Consider a classification problems, as described below. Let Z=X×Y, where X denotes the input space, and Y={1, . . . . K} denotes the label space. Given a base-model training set D_{B}={xᵢ^{B}, yᵢ^{B}}ᵢ₌₁^{N}^{_{B}}∈ Z^{N}^{^{B}} containing i.i.d. (Independent and identically distributed) samples generated from the distribution P_{Z}^{B}, a pretrained base model h∘Φ: X→Δ^{K-1} is constructed, where Φ: X→ [symbol] and h: [symbol] →Δ^{K-1} denote two complementary components of the neural network. More specifically, Φ(x)=Φ(x; w_{ϕ}) stands for the intermediate feature representation of the base model, and the model output h(Φ(x))=h (Φ(x; w_{ϕ}); wₕ) denotes the predicted label distribution P_{B}(y|Φ(x)) ∈ Δ^{K-1}, given input sample x, where (w_{ϕ}, wₕ) ∈ W are the parameters of the pretrained base model.

The performance of the base model is evaluated by a non-negative loss function [symbol] :W×Z→ [symbol] ; e.g., cross entropy loss. Thus, a standard way to obtain the pretrained base model is by minimizing the empirical risk over D_{B}, i.e.,

$${ℒ}_{B} ( h ∘ Φ , {D}_{B} ) {=}^{Δ} \frac{1}{{N}_{B}} {\sum }_{i = 1}^{{N}_{B}} {ℓ}_{B} ( h ∘ Φ , ( {x}_{i}^{B} , {y}_{i}^{B} ) ) .$$

Although the well-trained deep base model is able to achieve good prediction accuracy, the output label distribution P_{B}(y|Φ(x)) is usually unreliable for uncertainty quantification, i.e., it can be overconfident or poorly calibrated. Without retraining the model from scratch, an interest is in improving the uncertainty quantification performance in an efficient post-hoc manner. A meta-model g: [symbol] →Ŷ with parameter wⱼ ∈ W_{g} was used building on top of the base model. The meta-model shares the same feature extractor from the base model and generates an output \tilde{y}=g(Φ(x); w_{g}), where \tilde{y} ∈ \tilde{Y} can take any form, e.g., a distribution over Δ^{K-1} or a scalar. Given a meta-model training set D_{M}={xᵢ^{M}, yᵢ^{M}}ᵢ₌₁^{N}^{^{M}} with i.i.d. samples from the distribution P_{Z}^{M} one goal is to obtain the meta-model by optimizing a training objective

$${ℒ}_{M} ( g ∘ Φ , {D}_{M} ) {=}^{Δ} \frac{1}{{N}_{M}} {\sum }_{i = 1}^{{N}_{M}} {ℓ}_{M} ( g ∘ Φ , ( {x}_{i}^{M} , {y}_{i}^{M} ) ) ,$$

where [symbol] :W_{g}×W_{ϕ}×Z→ [symbol] is the loss function for the meta-model.

In the following, the post-hoc uncertainty learning problem using meta-model is formally introduced.

### Problem 1: Post-Hoc Uncertainty Learning by Meta-Model

Given a base model h∘Φ learned from the base-model training set D_{B}, the uncertainty learning problem by meta-model is to learn the function g using the meta-model training set D_{M} and the shared feature extractor Φ, i.e.,

$${g}^{*} = {arg}_{g} min {ℒ}_{M} ( g ∘ Φ , {D}_{M} ) , \qquad ( 1 )$$

such that the output from the meta-model \tilde{y}=g(Φ(x)) equipped with an uncertainty metric function u: \tilde{Y}→ [symbol] is able to generate a robust uncertainty score u(\tilde{y}).

Next, the most critical questions are how the meta-model should use the information extracted from the pretrained base model, what kinds of uncertainty the meta-model should aim to quantify, and finally, how to train the meta-model appropriately.

### Method

The post-hoc uncertainty learning framework defined in Problem 1 is specified below. First, the structure of the meta-model is introduced. Next, the meta-model training procedure, including the training objectives and a validation trick, is discussed. Finally, metrics for uncertainty quantification used in different applications are defined.

The design of an exemplary meta-model method is based on three high-level insights: first, different intermediate layers of the base model usually capture various levels of feature representation, from low-level features to high-frequency features, e.g., for OOD detection task, the OOD data is unlikely to be similar to in-distribution data across all levels of feature representations. Therefore, it is desirable to leverage the diversity in feature representations to achieve better uncertainty quantification performance. Second, the Bayesian method is used to model different types of uncertainty for various uncertainty quantification applications, i.e., total uncertainty and epistemic uncertainty. Thus, a Bayesian meta-model is disclosed to parameterize the Dirichlet distribution, used as the conjugate prior distribution, over label distribution. Third, the overconfident issue of the base model is believed to be caused by over-fitting in supervised learning with cross-entropy loss. In the post-hoc training of the meta-model, a validation strategy is proposed to improve the performance of uncertain learning instead of prediction accuracy.

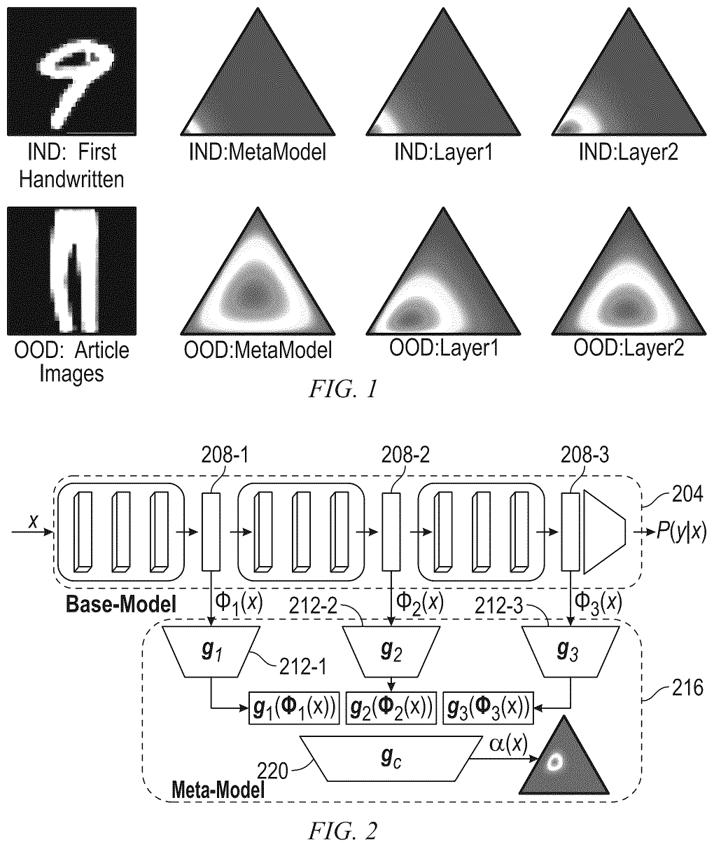

FIG. 1 illustrates a toy example of the disclosed meta-model method in an OOD detection application that shows the diversity of features in different layers, in accordance with an example embodiment. In one example embodiment, the meta-model utilizes two intermediate features, while Layer1 and Layer2 are only trained with one individual feature. The toy example shown in FIG. 1 is used to elaborate the above insights. The goal is to improve the OOD (a conventional dataset of article images) detection performance of a first conventional convolutional neural network base model trained on a first conventional large database of handwritten digits. The exemplary meta-model takes a base-model intermediate feature representation as input and parameterizes a Dirichlet distribution over the probability simplex. Three different meta-models are trained using both intermediate layer features, using either of the two features, respectively, and the output Dirichlet distribution on the simplex is then visualized and compared. Specifically, the three dominant classes with the largest logits are taken to approximately visualize the Dirichlet distribution over the probability simplex. It was observed that the meta-model outputs a much sharper distribution for the in-distribution (IND) sample than the OOD sample. Moreover, compared to the meta-model trained with one feature, the meta-model trained with multiple intermediate layers can further distinguish the two distributions on simplex. The meta-model trained with multiple intermediate layers generates a sharper distribution for the in-distribution sample while exhibiting a more uniform distribution for the OOD sample.

### Meta-Model Structure

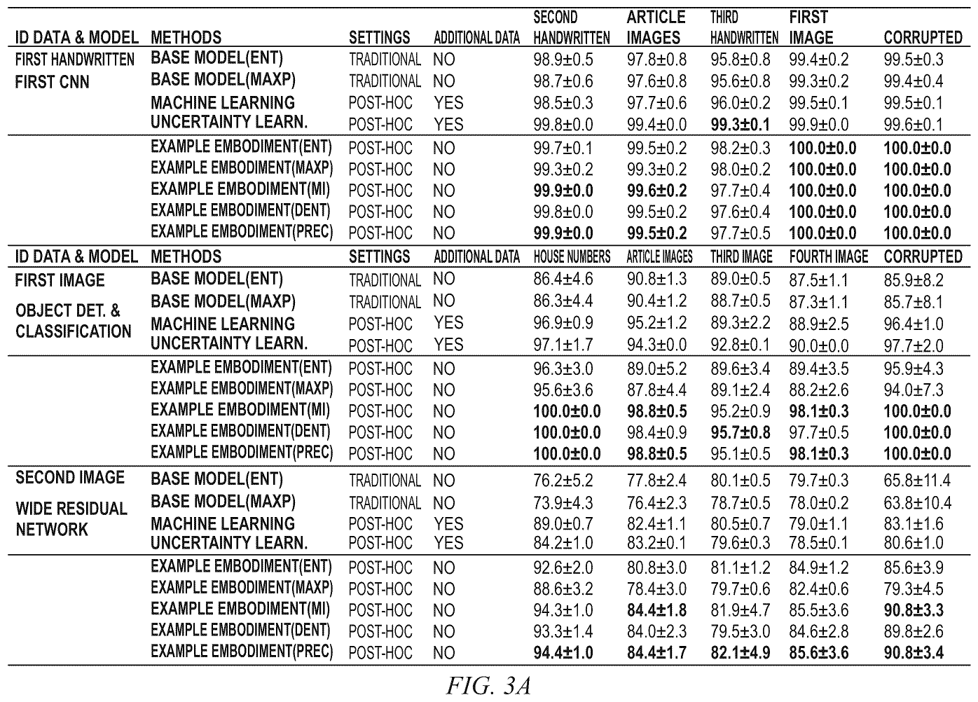

FIG. 2 illustrates the overall structure of a meta-model, in accordance with an example embodiment. The exemplary meta-model includes multiple linear layers 212-1, 212-2, 212-3 ({gⱼ}ⱼ₌₁^{m}) attached to different intermediate layers 208-1, 208-2, 208-3 from the base model 204, and a final linear layer 220 (g_{c}) that combines all the features and generates a single output. Specifically, given an input sample x, denote the multiple intermediate feature representation extracted from the base-model 204 as {Φⱼ(x)}ⱼ₌₁^{m} For each intermediate base-feature Φⱼ, the corresponding linear layer 212-1, 212-2, 212-3 will construct a low-dimensional meta-feature {gⱼ(Φⱼ(x))}ⱼ₌₁^{m}. Then, the final linear layer 220 of the meta-model 216 takes the multiple meta features as inputs and generates a single output, i.e., \tilde{y}=g({Φⱼ(x)}ⱼ₌₁^{m}; w_{g})=g_{c}({gⱼ(Φⱼ(x))}ⱼ₌₁^{m}; w_{g}_{_{c}}). In practice, the linear layers gᵢ and g_{c} may, for example, only consist of fully connected layers and an activation function, which ensures the meta-model 216 has a much simpler structure and enables efficient training.

Given an input sample x, the base model 204 outputs a conditional label distribution P_{B}(y|Φ(x))∈Δ^{K-1}, corresponding to a single point in the probability simplex. However, such label distribution P_{B}(y|Φ(x)) is a point estimate, which only shows the model's uncertainty about different classes but cannot reflect the uncertainty due to the lack of knowledge of a given sample, i.e., the epistemic uncertainty. To this end, the Dirichlet technique is adopted in order to better quantify the epistemic uncertainty. Letting the label distribution as a random variable over probability simplex be denoted as π=[π₁, π₂, . . . , πₖ], the Dirichlet prior distribution is the conjugate prior of the categorical distribution, i.e.,

$$D i r ( π \vert α ) {=}^{Δ} \frac{Γ ( {α}_{0} )}{{\prod }_{c = 1}^{K} Γ ( {α}_{c} )} {\prod }_{c = 1}^{K} {π}_{c}^{{α}_{c} - 1} , {α}_{c} > 0 , {α}_{0} {=}^{Δ} {\sum }_{c = 1}^{K} {α}_{c} , \qquad ( 2 )$$

The exemplary meta-model g explicitly parameterizes the posterior Dirichlet distribution, i.e,

$$q ( π \vert Φ ( x ) ; {w}_{g} ) {=}^{Δ} Dir ( π \vert α ( x ) ) , α ( x ) = {e}^{g ( Φ ( x ) ; {w}_{g} )} ,$$

where the output of the disclosed meta-model 216 is \tilde{y}=log α(x), and α(x)=[α₁(x), a₂(x), . . . , αₖ(x)] is the concentration parameter of the Dirichlet distribution given an input x.

### Uncertainty Learning

### Training Objective

From a Bayesian perspective, the predicted label distribution using the Dirichlet meta-model is given by the expected categorical distribution:

$$q ( y = c \vert Φ ( x ) ; {w}_{g} ) = {𝔼}_{q ( π \vert Φ ( x ) ; {w}_{g} )} [ P ( y = c \vert π ) ] = \frac{{α}_{c} ( x )}{{α}_{0} ( x )} , \qquad ( 3 )$$

where α₀=Σ_{c=1}^{k} α_{c} is the precision of the Dirichlet distribution.

The true posterior of the categorical distribution over sample (x y) is P(π|Φ(x),y)∝P(y|π, Φ(x))P(π|Φ(x)), which is difficult to evaluate. Instead, a variational inference technique is used to generate a variational distribution q(π|Φ(x); w_{g}) parameterized by Dirichlet distribution with meta-model to approximate the true posterior distribution P(π|Φ(x),y), then minimize the KL-divergence KL(q(π|Φ(x); w_{g})∥P(π|Φ(x),y)), which is equivalent to maximizing the evidence lower bound (ELBO) loss, i.e.,

$${ℒ}_{V I} ( {w}_{g} ) = \frac{1}{{N}_{M}} {\sum }_{i = 1}^{{N}_{M}} {𝔼}_{q ( π \vert Φ ( {x}_{i} ) ; {w}_{g} )} [ log P ( {y}_{i} \vert π , {x}_{i} ) ] - λ \cdot KL ( q ( π \vert Φ ( {x}_{i} ) ; {w}_{g} ) ‖ P ( π \vert Φ ( {x}_{i} ) ) ) \qquad ( 4 )$$

$$= \frac{1}{{N}_{M}} {\sum }_{i = 1}^{{N}_{M}} ψ ( {α}_{{y}_{i}}^{( i )} ) - ψ ( {α}_{0}^{( i )} ) - λ \cdot KL ( D i r ( π \vert {α}^{( i )} ) ‖ Di r ( π \vert β ) ) , \qquad ( 5 )$$

where α⁽ⁱ⁾ is the Dirichlet concentration parameter parameterized by the meta-model 216, i.e., α⁽ⁱ⁾=e(^{g(Φ(x}^{_{i); w}}^{_{g)}}), ψ is the digamma function, and β is the predefined concentration parameter of prior distribution. In practice, β is simply let to be equal to [1, . . . , 1]. The likelihood term encourages the categorical distribution to be sharper around the true class on the simplex, the KL-divergence term can be viewed as a regularizer to prevent overconfident prediction, and λ is the hyper-parameter to balance the trade-off.

### Validation for Uncertainty Learning

Validation with early stopping is a commonly used technique in supervised learning to train a model with desired generalization performance, i.e., stop training when the error evaluated on the validation set starts increasing. However, we have found that the standard validation method does not work well for uncertainty learning. One possible explanation is that the model achieves the highest accuracy when the validation loss is small, but may not achieve the best UQ performance, i.e., the model can be overconfident. To this end, an exemplary simple and effective validation approach is disclosed specifically for uncertainty learning. Instead of monitoring the validation cross-entropy loss, a specific uncertainty quantification performance metric is evaluated. For example, another noisy validation set for the OOD task is created by adding noise to the original validation samples and such noisy validation samples are treated as OOD samples (more details are provided in the section entitled “Description of OOD datasets”). The uncertainty score u(\tilde{y}) is evaluated on both the validation set and the noisy validation set, and the meta-model training is stopped when the OOD detection performance achieves its maximum based on some predefined metrics, e.g., area under the receiver operating characteristic (ROC) curve (AUROC) score. Unlike most existing techniques using additional training data to help achieve a desired performance, in one or more embodiments, no additional data is required for training the meta-model.

### Uncertainty Metrics

It is shown below that the exemplary meta-model 216 has the desired behavior to quantify different uncertainties and how they can be used in various applications.

### Total Uncertainty

Total uncertainty, also known as predictive uncertainty, is a combination of epistemic uncertainty and aleatoric uncertainty. The total uncertainty is often used for misclassification detection problems, where the misclassified samples are viewed as in-distribution hard samples. There are two standard ways to measure total uncertainty: (1) Entropy (Ent): the Shannon entropy of expected categorical label distribution over the Dirichlet distribution, i.e., H(P(y|Φ(xᵢ), w_{g}))=H( [symbol] _{(π|Φ(x); w}_{_{g}}₎[P(y|π)]); and (2) Max Probability (MaxP): the probability of the predicted class in label distribution, i.e., max_{c}P(y=c|Φ(x); w_{g}).

### Epistemic Uncertainty

The epistemic uncertainty quantifies the uncertainty when the model has insufficient knowledge of a prediction, e.g., the case of an unseen data sample. The epistemic uncertainty is especially useful in OOD detection problems. When the meta-model 216 encounters an unseen sample during testing, it will output a high epistemic uncertainty score due to a lack of knowledge. Three metrics are defined to measure the epistemic uncertainties.

### Differential Entropy (Dent)

Differential entropy measures the entropy of the Dirichlet distribution, a large differential entropy corresponds to a more spread Dirichlet distribution, i.e., H(P(π|Φ(xᵢ), w_{g}))=−∫P(π|Φ(xᵢ), w_{g})·log P(π|Φ(xᵢ); w_{g})dπ.

### Mutual Information (MI)

Mutual Information is the difference between the Entropy (measures total uncertainty) and the expected entropy of the categorical distribution sampled from the Dirichlet distribution (approximates aleatoric uncertainty), i.e.,

$$I ( y , π \vert Φ ( {x}_{i} ) ) = H ( {𝔼}_{P ( π \vert Φ ( x ) ; {w}_{g} )} [ P ( y \vert π ) ] ) - {𝔼}_{P ( π \vert Φ ( x ) ; {w}_{g} )} [ H ( P ( y \vert π ) ) ] .$$

### Precision (Prec)

The precision is the summation of the Dirichlet distribution concentration parameter α, where a larger value corresponds to sharper distribution and higher confidence, i.e., α₀=Σ_{c=1}α_{c}.

### Experiment Results

The strong empirical performance of the exemplary meta-model-based uncertainty learning method is demonstrated below: first, the UQ applications are introduced; the experiment settings are described; next, the main results of the three aforementioned uncertainty quantification applications are presented; and finally, the take-aways are discussed. More experiment results and implementation details are given in the sections entitled “Experiment Setup” and “Additional Experiment results.

### Uncertainty Quantification Applications

Three exemplary applications that can be tackled using the disclosed meta-model approach are focused on below:

### Out of Domain Data Detection

Given a base-model h trained using data sampled from the distribution P_{Z}^{B}, the same base-model training set is used to train the meta-model 216, i.e., D_{B}=D_{M}. During testing, there exists some unobserved out-of-domain data from another distribution p_{Z}^{ood}. The meta-model 216 is expected to identify the out-of-distribution input sample based on epistemic uncertainties.

### Misclassification Detection

Instead of detecting whether a testing sample is out of domain, the goal here is to identify the failure or success of the meta-model prediction at test time using total uncertainties.

### Trustworthy Transfer Learning

In transfer learning, there exists a pretrained model trained using source task data Ds sampled from source distribution P_{Z}^{s}, and the goal is to adapt the source model to a target task using target data Dₜ sampled from target distribution P_{Z}^{t}. Most existing transfer learning approaches only focus on improving the prediction performance of the transferred model, but ignore its UQ performance on the target task. The disclosed meta-model method can be utilized to address this problem, i.e., given pretrained source model h^{s}∘Φ^{s}, the meta-model 216 can be efficiently trained using target domain data by g^{t}=argmin_{g} [symbol] (g∘Φ^{s}, Dₜ).

### Settings

### Benchmark

For both OOD detection and misclassification detection tasks, three standard datasets are employed to train the base model 204 and the meta-model 216: the first conventional large database of handwritten digits, a first conventional image dataset, and a second conventional image dataset. For each dataset, different base-model structures are used, i.e., a first conventional convolutional neural network for the first conventional large database of handwritten digits, a conventional object detection and classification algorithm for the first conventional image dataset, and a conventional wide residual network for the second conventional image dataset. For the first conventional convolutional neural network and the conventional object detection and classification algorithm, the meta-model 216 uses the extracted feature after each pooling layer, and for the conventional wide residual network, the meta-model 216 uses the extracted feature after each residual block. In general, the total number of intermediate features is less than five, to ensure computational efficiency. For the OOD task, five different OOD datasets are considered for evaluating the OOD detection performance: a second conventional large database of handwritten digits, a conventional dataset of article images, a third conventional large database of handwritten digits, the first conventional image dataset, and a corrupted version of the first conventional large database of handwritten digits as outliers for the first conventional large database of handwritten digits; a conventional database of house numbers, the conventional dataset of article images, a third conventional image dataset, a fourth conventional image dataset, and a corrupted version of the first conventional image dataset (a corrupted version of the second conventional image dataset) as outliers for the first conventional image dataset (the second conventional image dataset) dataset. For the trustworthy transfer learning task, a second conventional convolutional neural network pretrained on a fifth conventional image dataset was used as the pretrained source domain model and the source model was adapted to the two target datasets, a sixth conventional image dataset and the first conventional image dataset, by training the meta-model 216.

### Baselines

For OOD and misclassification tasks, except for the naive base-model trained with cross-entropy loss, an exemplary technique is mainly compared with the existing post-hoc UQ methods as baselines: (1) the meta-model based method; and (2) a post-hoc uncertainty quantification using Laplace Approximation. In order to further validate the strong empirical performance, the disclosed method was also compared with other state-of-the-art (SOTA) intrinsic UQ methods in the section entitled “Additional Experiment Results”: (1) a standard Bayesian method; (2) a Dirichlet network with variational inference; (3) the posterior network with density estimation; and (4) a robust OOD detection method.

For the trustworthy transfer learning task, since there is no existing work designed for this problem, the exemplary technique was compared with two simple baselines: (1) fine-tune the last layer of the source model; and (2) train the disclosed meta-model on top of the source model using standard cross-entropy loss.

### Performance Metrics

The UQ performance was evaluated by measuring the area under the ROC curve (AUROC) and the area under the Precision-Recall curve (AUPR). The results are averaged over five random trials for each experiment. For the OOD task, the in-distribution test samples are considered as the negative class and the outlier samples as the positive class. For the misclassification task, the correctly classified test samples are considered as the negative class and the miss-classified test samples are considered as the positive class.

### OOD Detection

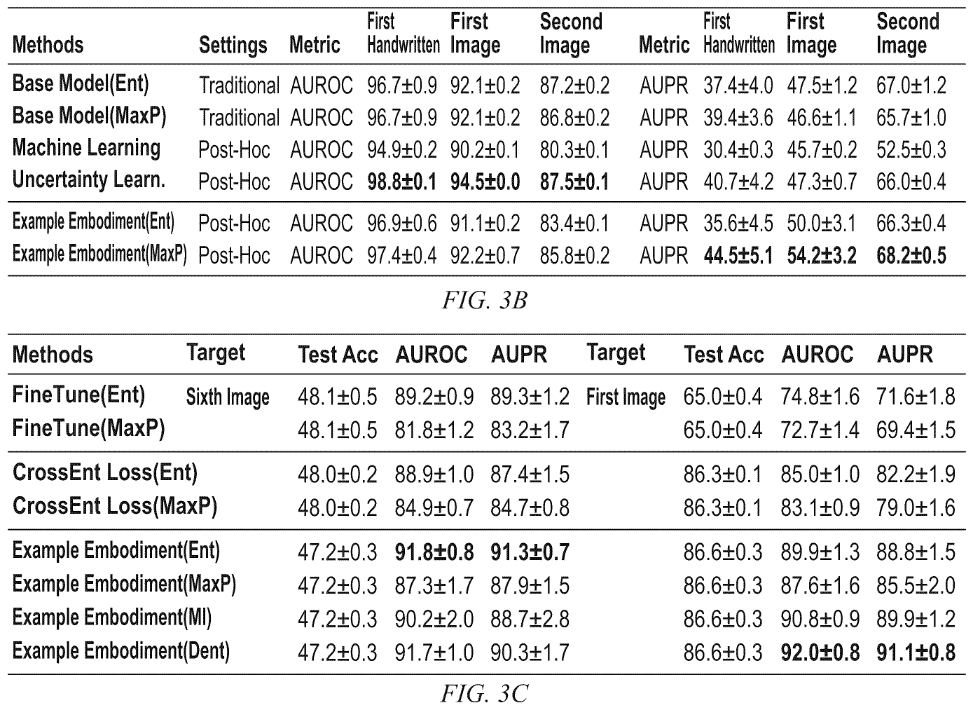

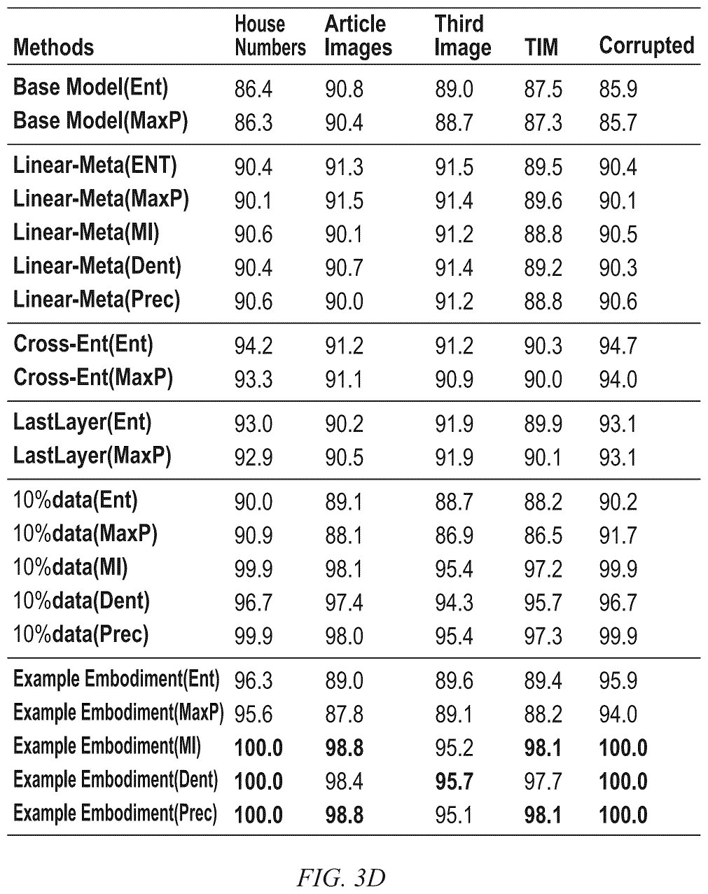

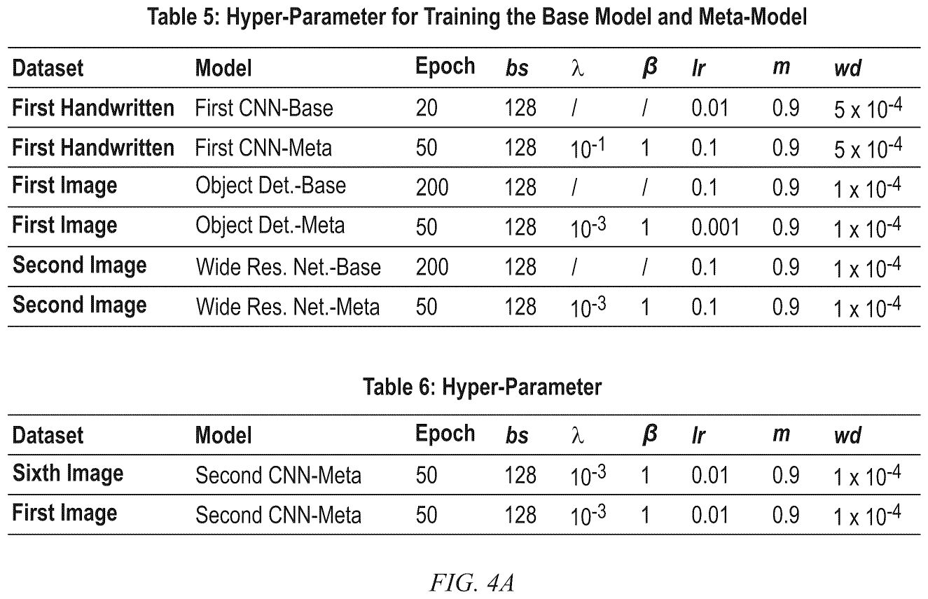

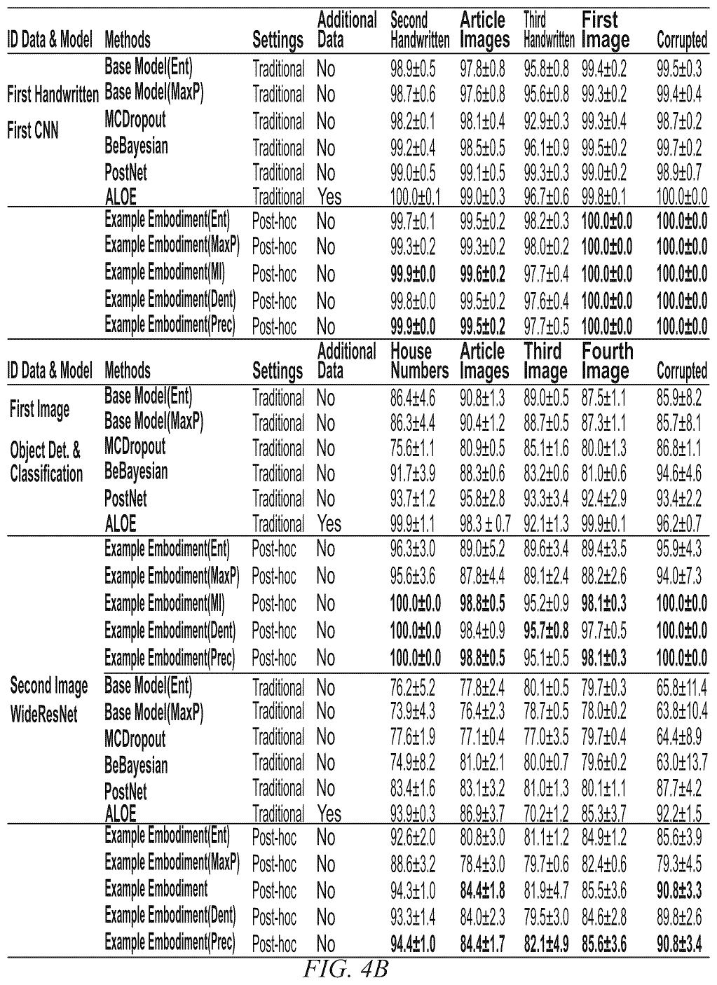

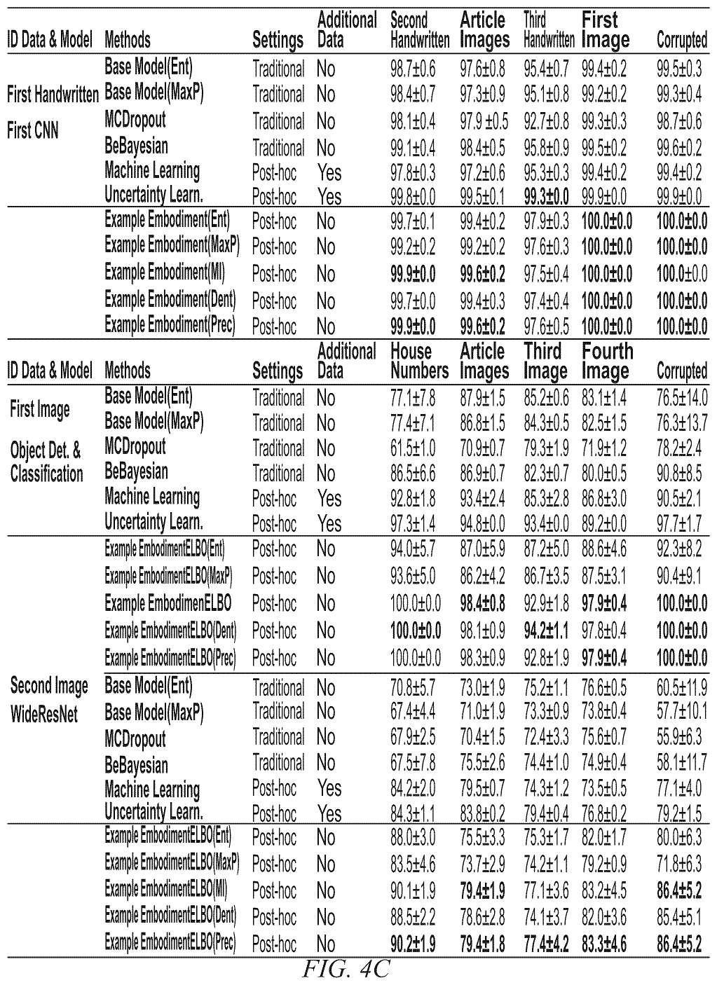

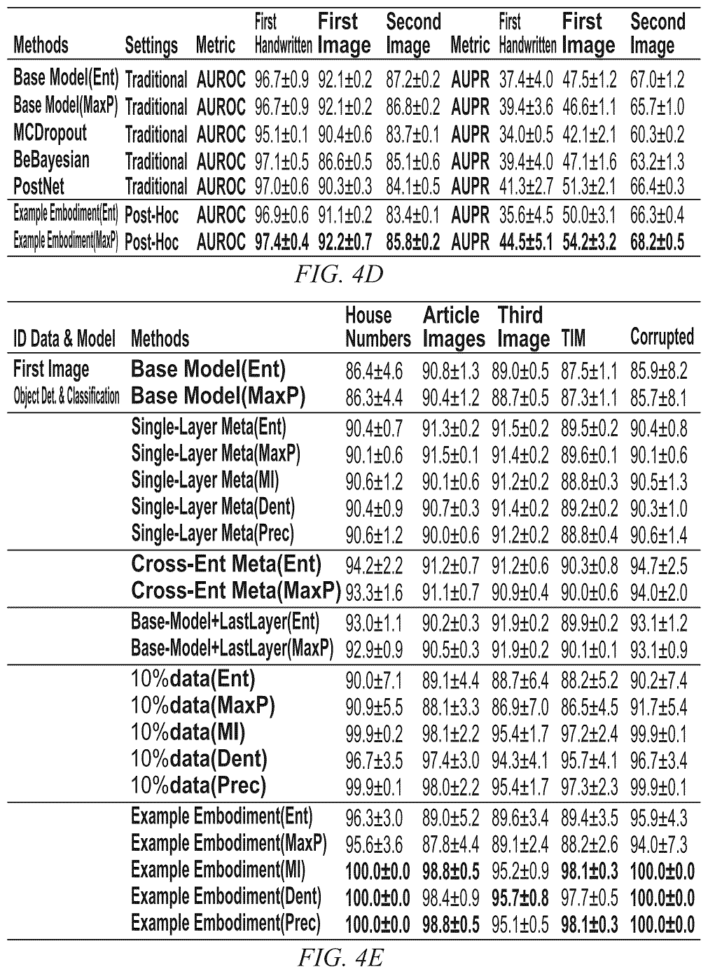

FIG. 3A is a table of the OOD detection results (AUROC score) for three benchmark datasets, in accordance with an example embodiment. The three benchmark datasets include the first conventional large database of handwritten digits, the first conventional image dataset, and the second conventional image dataset. (MI, Dent, and Prec stand for different epistemic uncertainty metrics, i.e., Mutual Information, Differential Entropy, and precision. Settings stand for post-hoc or traditional, i.e., training the entire model from scratch. Additional Data stands indicates whether using additional training data or not.) Additional baseline comparisons are provided in the table of FIG. 4B. The disclosed Dirichlet meta-model method consistently outperforms all the baseline methods in terms of AUROC score (AUPR results are shown in the sections entitled “Experiment Setup” and “Additional Experiment Results”), including the conventional SOTA post-hoc uncertainty learning method. The performance of all the uncertainty metrics defined in the section entitled “Uncertainty Metrics” were also evaluated, as it can be observed that compared to total uncertainty (Ent and MaxP), epistemic uncertainties (MI, Dent, Prec) can achieve better UQ performance for the OOD detection task. Moreover, the exemplary method does not require additional data to train the meta-model 216. In contrast, one conventional machine learning model requires an additional validation set to train the meta-model 216, and the conventional post-hoc uncertainty learning method also needs an additional OOD dataset during training to distinguish the in-distribution samples and outliers, which imposes practical limitations.

### Misclassification Detection

FIG. 3B is a table of the misclassification detection results for the three bench-mark datasets, the first conventional large database of handwritten digits, the first conventional image dataset, and the second conventional image dataset, in accordance with an example embodiment. (Ent and MaxP stand for Entropy and Max Probability, respectively. Settings stand for post-hoc or traditional, i.e., training the entire model from scratch.) FIG. 4D is a table showing a comparison of the misclassification results, in accordance with an example embodiment. (In the table of FIG. 4D, Ent and MaxP stand for Entropy and Max Probability, respectively. Settings stand for post-hoc or traditional, i.e., training the entire model from scratch.) The conventional post-hoc uncertainty learning method turns out to be a strong baseline for the misclassification detection task. Although the disclosed method performs slightly worse than the conventional post-hoc uncertainty learning method in terms of the AUROC, it outperforms all the baselines in terms of AUPR.

### Trustworthy Transfer Learning

The second conventional convolutional neural network pretrained on the fifth conventional image dataset was used as the source domain base model and the pretrained model was adapted to the target task by training the meta-model 216 using the target domain training data. Unlike traditional transfer learning, which only focuses on testing prediction accuracy on the target task, the UQ ability of the meta-model 216 was also evaluated in terms of OOD detection performance. A conventional dataset of article images was used as OOD samples for both target datasets, the sixth conventional image dataset and the first conventional image dataset, and the AUROC score was evaluated. FIG. 3C is a table of Trustworthy Transfer Learning Results, in accordance with an example embodiment. (Ent, MaxP, MI, and Dent stand for different uncertainty measurements, i.e., Entropy, Max Probability, Mutual Information, and Differential Entropy, respectively.) The second conventional convolutional neural network pretrained with the fifth conventional image dataset was used as the source model and a conventional dataset of article images as OOD samples. The disclosed meta-model method can achieve comparable prediction performance to the baseline methods and significantly improves the OOD detection performance, which is pertinent in trustworthy transfer learning.

The disclosed method was further investigated through an ablation study using the first conventional image dataset OOD task. Based on the disclosed insights and the empirical results, it was concluded that the following four pertinent factors relate to the success of the exemplary meta-model based method:

### Feature Diversity

The disclosed meta-model structure was replaced with a simple linear classifier attached to only the final layer. FIG. 3D is a table of an Ablation Study of Meta-model (“Linear-Meta”), in accordance with an example embodiment. (The first conventional image dataset AUROC score. The results are reported as mean over five experiment trials. It can be observed here and in FIG. 1 that the performance degrades without using features from all intermediate layers, which further illustrates the pertinence of feature diversity and the effectiveness of the disclosed meta-model structure.

### Dirichlet Technique

Instead of using a meta-model to parameterize a Dirichlet distribution, the meta-model 216 was trained using the standard cross-entropy loss, which simply outputs a categorical label distribution. The ablation results are shown in the table of FIG. 3D as “Cross-Ent”. It can be shown that performance degrades again because it cannot quantify epistemic uncertainty, which justifies the effectiveness of using Bayesian techniques.

### Validation for Uncertainty Learning

The last layer of the base model 204 is retrained using the cross-entropy loss with the exemplary validation trick. The results are shown in the table of FIG. 3D as “LastLayer”. It turns out that even such a naive method can achieve improved performance compared to the base model 204, which further justifies the effectiveness of the post-hoc uncertainty learning setting, i.e., the benefit of solely focusing on UQ performance at the second stage. This interesting observation suggests that efficiently retraining the classifier of the base model 204 at the second stage will lead to better UQ performance.

### Data Efficiency

Instead of using all the training samples, only 10% of samples to train the meta-model were randomly chosen. The results are shown in the table of FIG. 3D as “10% data”. It can be observed that the exemplary meta-model 216 requires a small amount of data to achieve comparable performance due to the smaller model complexity. Therefore, the exemplary method is also more computationally efficient than the approaches that retrain the whole model from scratch.

The exemplary meta-model approach is believed to not only have the flexibility to tackle other applications relevant to uncertainty quantification, such as quantifying transferability in transfer learning and domain, but also to be adaptable to other model architectures, such as transformer and language model.

### Experiment Setup

### Implementation Details for OOD and Misclassification

The post-hoc uncertainty learning problem aims to improve the UQ performance of a pretrained base model. First, the pretrained model is generated by training the base model using cross-entropy loss to achieve optimal testing accuracy. The maximum epochs for training the first conventional convolutional neural network, the conventional object detection and classification algorithm, and the conventional wide residual network are set to be 20, 200, and 200, respectively. Then, in the second stage, the parameter of the pretrained base model is frozen and the meta-model is trained on top of it using the Dirichlet variational loss. The meta-model uses the same training data as the base model, and the maximum epochs for training the meta-model is set to be 50. All the models are optimized using a stochastic gradient descent (SGDO optimizer. FIG. 4A is a table summarizing the hyperparameters for training the base model and meta-model and a table summarizing the hyperparameters for training the meta-model, in accordance with an example embodiment. (In the tables of FIG. 4A, bs denotes the batch size, Ir denotes the learning rate, m denotes the momentum, wd denotes the weight decay, A is the hyper-parameter to balance the two terms in variational loss, and β is the concentration parameter of prior Dirichlet distribution.) All experiments are implemented on a conventional machine learning framework using conventional graphical processing units with 24 GB memory.

### Implementation Details of Trustworthy

### Transfer Learning

The pretrained second conventional convolutional neural network was trained on the fifth conventional image dataset as the base-model. Similarly, the parameter of the pretrained model was frozen and the meta-model was trained on top of it using the training data of the target task. All the models are optimized using an SGD optimizer. The hyper-parameters for training the meta-model are summarized in the table of FIG. 4A.

### Meta-Model Structure

The high-level description of the meta-model structure is provided in the section entitled “Meta-model Structure.” More specifically, all the linear layers gᵢ and g_{c} include three elements: a fully-connected layer, a rectified linear unit (ReLU) activation function, and Max-Pooling. Each gᵢ has multiple fully-connected layers, each is followed by a (ReLU) and a Max-Pooling, each fully-connected layer reduces the input feature dimension to half size, and the output meta-feature of gᵢ has the dimension as the class number, e.g., 10 for the first conventional image dataset. The final linear layer g_{c} is a single fully-connected layer that takes the concatenation of all the meta-feature and outputs the concentration parameter α.

### Training Time Complexity

An exemplary meta-model-based approach is much more efficient than traditional uncertainty quantification approaches due to the simpler structure and faster convergence speed. To quantitatively demonstrate such efficiency, the wall clock time of training the meta-model is measured in seconds (on a single_conventional graphical processing unit (GPU)) as follows. The training time of training the conventional object detection and classification algorithm (model) on the first conventional image dataset is 66.5 seconds(s) for five epochs; the training time of training the conventional wide residual network model on the second conventional image dataset is 241.9 s for ten epochs. The training time of the meta-model can be negligible compared to the approaches training the entire base model from scratch (usually taking several hours).

### Validation for Uncertainty Learning

The proposed validation trick described in the section entitled “Uncertainty Learning” was used to perform early stopping in the training of the meta-model. 20% of the original training data was randomly selected as the validation set. For the OOD detection task, the noisy validation set was created by applying various kinds of noise and perturbation to the original images, including permuting the pixels, applying Gaussian blurring, and performing contrast re-scaling. For the misclassification task, the validation set was directly used to evaluate the misclassification detection performance with the correctly classified and misclassified validation samples.

### Description of OOD Datasets

For the OOD detection task, the testing set was used as an in-domain dataset, and the out of domain dataset was ensured to have the same number of samples (10000 samples) as in-domain dataset. Different dataset input images are resized to, for example, 32×32 to ensure they have the same size, and all gray-scale images are converted into three-channel images. The following datasets were used as OOD samples for the OOD detection task:

A fourth conventional large database of handwritten digits contains 1632 hand-written characters taken from 50 different alphabets. 10,000 images were randomly picked from its testing set as OOD samples for the first conventional large database of handwritten digits.

The conventional dataset of article images with 10,000 images was used as OOD samples for both the first conventional large database of handwritten digits and CIFAR (including CIFAR-10 and CIFAR-100).

The third conventional large database of handwritten digits contains handwritten characters from the Japanese texts. The testing set with 10,000 images was used as OOD samples for the first conventional large database of handwritten digits.

The conventional database of house numbers contains images of house numbers. The testing set with 10,000 images was used as OOD samples for CIFAR.

The third conventional image dataset is a dataset of different objects taken from 10 different scene categories. The images from the classroom categories were used and 10,000 training images were randomly sampled as OOD samples for CIFAR.

The fourth conventional image dataset is a subset of the fifth conventional image dataset, and the validation set with 10,000 images was used as OOD samples for CIFAR.

Corrupted is an artificial dataset generated by perturbing the original testing images using Gaussian blurring, pixel permutation, and contrast re-scaling.

### Additional Experiment Results

### OOD Detection

In the following, an exemplary embodiment is compared with several SOTA uncertainty quantification methods with traditional settings on the OOD detection task. FIGS. 4B and 4C are tables showing the results for an OOD detection AUROC score, in accordance with an example embodiment. (MI, Dent, and Prec stand for different epistemic uncertainty metrics, i.e., Mutual Information, Differential Entropy, and precision. Settings stand for post-hoc or traditional, i.e., training the entire model from scratch. Additional Data stands for if using additional training data or not.) The exemplary embodiment can still outperform these methods.

### Misclassification Detection

In the following, an exemplary embodiment was compared with several SOTA uncertainty quantification methods with traditional settings on the misclassification detection task. FIG. 4D is a table showing the misclassification results, in accordance with an example embodiment. (Ent and MaxP stand for Entropy and Max Probability, respectively. Settings stand for post-hoc or traditional, i.e., training the entire model from scratch.)

### Ablation Study

FIG. 4E is a table showing the complete results of ablation_study, in accordance with an example embodiment.

Given the discussion thus far, it will be appreciated that, in general terms, an exemplary method, according to an aspect of the invention, includes the operations of obtaining a pretrained machine learning model; configuring a Bayesian meta-model 216 to cooperate with the pretrained machine learning model 204, the Bayesian meta-model 216 being configured to quantify different kinds of uncertainties associated with the pretrained machine learning model 204, wherein the Bayesian meta-model 216 comprises a plurality of linear layers 212-1, 212-2, 212-3 attached to different intermediate features of the pretrained machine learning model 204 with a final linear layer 220 generating a Dirichlet distribution; receiving multiple intermediate features extracted from the pretrained machine learning model 204 as inputs; generating a Dirichlet distribution over a probability simplex as output, wherein the Dirichlet distribution is parameterized by the Bayesian meta-model 216 and allows quantification of uncertainty of model prediction; and using the Bayesian meta-model 216 and the pretrained machine learning model 204 in a downstream task.

In one aspect, a computer program product comprises one or more tangible computer-readable storage media and program instructions stored on at least one of the one or more tangible computer-readable storage media, the program instructions executable by a processor, the program instructions comprising obtaining a pretrained machine learning model; configuring a Bayesian meta-model 216 to cooperate with the pretrained machine learning model 204, the Bayesian meta-model 216 being configured to quantify different kinds of uncertainties associated with the pretrained machine learning model 204, wherein the Bayesian meta-model 216 comprises a plurality of linear layers 212-1, 212-2, 212-3 attached to different intermediate features of the pretrained machine learning model 204 with a final linear layer 220 generating a Dirichlet distribution; receiving multiple intermediate features extracted from the pretrained machine learning model 204 as inputs; generating a Dirichlet distribution over a probability simplex as output, wherein the Dirichlet distribution is parameterized by the Bayesian meta-model 216 and allows quantification of uncertainty of model prediction; and using the Bayesian meta-model 216 and the pretrained machine learning model 204 in a downstream task.

In one aspect, a system comprises a memory and at least one processor coupled to the memory, and operative to perform operations comprising obtaining a pretrained machine learning model; configuring a Bayesian meta-model 216 to cooperate with the pretrained machine learning model 204, the Bayesian meta-model 216 being configured to quantify different kinds of uncertainties associated with the pretrained machine learning model 204, wherein the Bayesian meta-model 216 comprises a plurality of linear layers 212-1, 212-2, 212-3 attached to different intermediate features of the pretrained machine learning model 204 with a final linear layer 220 generating a Dirichlet distribution; receiving multiple intermediate features extracted from the pretrained machine learning model 204 as inputs; generating a Dirichlet distribution over a probability simplex as output, wherein the Dirichlet distribution is parameterized by the Bayesian meta-model 216 and allows quantification of uncertainty of model prediction; and using the Bayesian meta-model 216 and the pretrained machine learning model 204 in a downstream task.

In one example embodiment, the configuring of the Bayesian meta-model to cooperate with the pretrained machine learning model is performed without modifying the pretrained machine learning model.

In one example embodiment, the Bayesian meta-model is trained using a Bayesian variational loss on a training dataset and using a validation process to ensure the Bayesian meta-model achieves optimal uncertainty quantification performance.

In one example embodiment, the validation process comprises generating a noisy validation set by adding noise to validation data; using the noisy validation data as an approximation of out-of-distribution (OOD) data; evaluating uncertainty quantification performance using the noisy validation set; and selecting the optimal uncertainty quantification performance.

In one example embodiment, meta-model training is stopped when an out-of-distribution (OOD) detection performance achieves its maximum based on predefined metrics.

In one example embodiment, the final linear layer combines all the intermediate features.

In one example embodiment, the Dirichlet distribution comprises a concentrated Dirichlet distribution over the probability simplex corresponding to confident prediction and comprises a diffused Dirichlet distribution corresponding to uncertain predictions.

In one example embodiment, the linear layers consist only of fully connected layers and activation functions.

In one example embodiment, the generating the Dirichlet distribution is based on a loss function and the loss function uses a likelihood term to encourage sharpening of a categorical distribution around a true class on the simplex and uses a KL-divergence term as a regularizer to prevent overconfident prediction, and a hyper-parameter is supplied to balance a trade-off between the sharpening of the categorical distribution and the prevention of the overconfident prediction. Further details regarding the loss function are provided above with regard to equations (4) and (5) and the accompanying text.

In one example embodiment, a physical system, such as an autonomous vehicle, is controlled using the Bayesian meta-model in conjunction with the pretrained machine learning model.

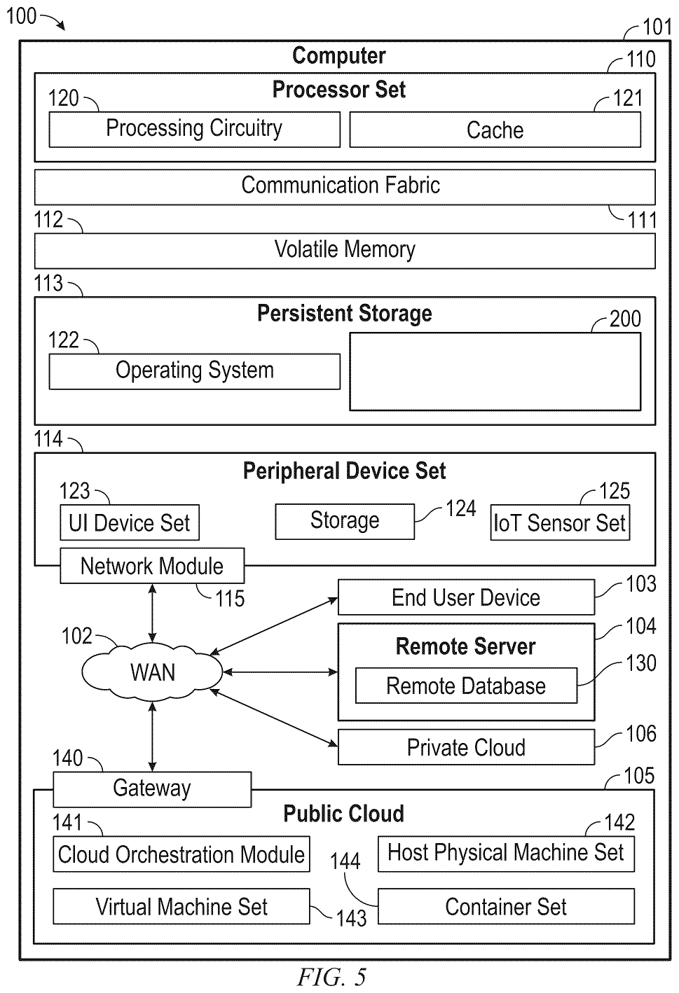

In one example embodiment, an operator such as a driver is alerted to assume control of the physical system such as an autonomous vehicle in response to a confidence level generated by the Bayesian meta-model in conjunction with the pretrained machine learning model being less than a given threshold. Generally, refer to FIG. 5—for example, code block 200 could implement aspects of the invention and the physical control and/or alert could occur over WAN 102, a physical cable, a wireless or wired LAN, and the like.

In one example embodiment, a predicted label distribution using the Dirichlet meta-model is given by an expected categorical distribution:

$$q ( y = c \vert Φ ( x ) ; {w}_{g} ) = {𝔼}_{q ( π \vert Φ ( x ) ; {w}_{g} )} [ P ( y = c \vert π ) ] = \frac{{α}_{c} ( x )}{{α}_{0} ( x )} ,$$

where α₀=Σ_{c=1}^{k}α_{c} is a precision of the Dirichlet distribution.

In one example embodiment, given an input sample x, a representation of the multiple intermediate features extracted from the pretrained machine learning model is denoted as {Φⱼ(x)}ⱼ₌₁^{m}, a corresponding linear layer will construct a low-dimensional meta-feature {gⱼ(Φⱼ(x))}ⱼ₌₁^{m}, wherein, for each intermediate base-feature Φⱼ, the final linear layer of the meta-model takes the multiple meta-features as inputs and generates a single output \tilde{y}=g({Φⱼ(x)}ⱼ₌₁^{m}; w_{g})=g_{c}({gⱼ(Φⱼ(x))}; w_{g}_{_{c}}), wherein denotes a corresponding intermediate base-feature and w_{g} is a parameter of the pretrained machine learning model. In one example embodiment, a medical diagnosis is generated and a medical treatment is performed wherein both operations are performed by and/or based on classifying medical diagnostic images using the Bayesian meta-model in conjunction with the pretrained machine learning model. In one example embodiment, a user, such as a medical practitioner, is alerted to inspect an image in response to a confidence level generated by the Bayesian meta-model in conjunction with the pretrained machine learning model being less than a given threshold.

In one example embodiment, an image of a license plate is classified using the Bayesian meta-model in conjunction with the pretrained machine learning model. In one example embodiment, a user is alerted to inspect an image of a license plate in response to a confidence level generated by the Bayesian meta-model in conjunction with the pretrained machine learning model being less than a given threshold.

Refer now to FIG. 5.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

Computing environment 100 contains an example of an environment for the execution of at least some of the computer code involved in performing the inventive methods, such as machine learning system 200 incorporating aspects of the invention. In addition to block 200, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and block 200, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 5. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 200 in persistent storage 113.

COMMUNICATION FABRIC 111 is the signal conduction path that allows the various components of computer 101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface-type operating systems that employ a kernel. The code included in block 200 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A computer-implemented method comprising:
obtaining a pretrained machine learning model;
configuring a Bayesian meta-model to cooperate with the pretrained machine learning model, the Bayesian meta-model being configured to quantify different kinds of uncertainties associated with the pretrained machine learning model, wherein the Bayesian meta-model comprises a plurality of linear layers attached to different intermediate features of the pretrained machine learning model with a final linear layer generating a Dirichlet distribution;
receiving multiple intermediate features extracted from the pretrained machine learning model as inputs;
generating a Dirichlet distribution over a probability simplex as output, wherein the Dirichlet distribution is parameterized by the Bayesian meta-model and allows quantification of uncertainty of model prediction; and
using the Bayesian meta-model and the pretrained machine learning model in a downstream task.

2. The computer-implemented method of claim 1, wherein the configuring of the Bayesian meta-model to cooperate with the pretrained machine learning model is performed without modifying the pretrained machine learning model.

3. The computer-implemented method of claim 1, further comprising training the Bayesian meta-model using a Bayesian variational loss on a training dataset and using a validation process to ensure the Bayesian meta-model achieves optimal uncertainty quantification performance.

4. The computer-implemented method of claim 3, wherein the validation process comprises:
generating a noisy validation set by adding noise to validation data;
using the noisy validation data as an approximation of out-of-distribution (OOD) data;
evaluating uncertainty quantification performance using the noisy validation set;
and selecting the optimal uncertainty quantification performance.

5. The computer-implemented method of claim 4, wherein meta-model training is stopped when an out-of-distribution (OOD) detection performance achieves its maximum based on predefined metrics.

6. The computer-implemented method of claim 1, wherein the final linear layer combines all the intermediate features.

7. The computer system of claim 1, wherein the Dirichlet distribution comprises a concentrated Dirichlet distribution over the probability simplex corresponding to confident prediction and comprises a diffused Dirichlet distribution corresponding to uncertain predictions.

8. The computer-implemented method of claim 1, wherein the linear layers consist only of fully connected layers and activation functions.

9. The computer-implemented method of claim 1, wherein the generating the Dirichlet distribution is based on a loss function and wherein the loss function uses a likelihood term to encourage sharpening of a categorical distribution around a true class on the simplex and uses a KL-divergence term as a regularizer to prevent overconfident prediction, and wherein a hyper-parameter is supplied to balance a trade-off between the sharpening of the categorical distribution and the prevention of the overconfident prediction.

10. The method of claim 1, further comprising controlling an autonomous vehicle using the Bayesian meta-model in conjunction with the pretrained machine learning model.

11. The method of claim 10, further comprising alerting a driver to assume control of the autonomous vehicle in response to a confidence level generated by the Bayesian meta-model in conjunction with the pretrained machine learning model being less than a given threshold.

12. A computer program product, comprising:
one or more tangible computer-readable storage media and program instructions stored on at least one of the one or more tangible computer-readable storage media, the program instructions executable by a processor, the program instructions comprising:
obtaining a pretrained machine learning model;
configuring a Bayesian meta-model to cooperate with the pretrained machine learning model, the Bayesian meta-model being configured to quantify different kinds of uncertainties associated with the pretrained machine learning model, wherein the Bayesian meta-model comprises a plurality of linear layers attached to different intermediate features of the pretrained machine learning model with a final linear layer generating a Dirichlet distribution;
receiving multiple intermediate features extracted from the pretrained machine learning model as inputs;
generating a Dirichlet distribution over a probability simplex as output, wherein the Dirichlet distribution is parameterized by the Bayesian meta-model and allows quantification of uncertainty of model prediction; and
using the Bayesian meta-model and the pretrained machine learning model in a downstream task.

13. A system comprising:
a memory; and
at least one processor, coupled to said memory, and operative to perform operations comprising:
obtaining a pretrained machine learning model;
configuring a Bayesian meta-model to cooperate with the pretrained machine learning model, the Bayesian meta-model being configured to quantify different kinds of uncertainties associated with the pretrained machine learning model, wherein the Bayesian meta-model comprises a plurality of linear layers attached to different intermediate features of the pretrained machine learning model with a final linear layer generating a Dirichlet distribution;
receiving multiple intermediate features extracted from the pretrained machine learning model as inputs;
generating a Dirichlet distribution over a probability simplex as output, wherein the Dirichlet distribution is parameterized by the Bayesian meta-model and allows quantification of uncertainty of model prediction; and
using the Bayesian meta-model and the pretrained machine learning model in a downstream task.

14. The system of claim 13, wherein the configuring of the Bayesian meta-model to cooperate with the pretrained machine learning model is performed without modifying the pretrained machine learning model.

15. The system of claim 13, the operations further comprising training the Bayesian meta-model using a Bayesian variational loss on a training dataset and using a validation process to ensure the Bayesian meta-model achieves optimal uncertainty quantification performance.

16. The system of claim 15, wherein the validation process comprises:
generating a noisy validation set by adding noise to validation data;
using the noisy validation data as an approximation of out-of-distribution (OOD) data;
evaluating uncertainty quantification performance using the noisy validation set;
and selecting the optimal uncertainty quantification performance.

17. The system of claim 16, wherein meta-model training is stopped when an out-of-distribution (OOD) detection performance achieves its maximum based on predefined metrics.

18. The system of claim 13, wherein the final linear layer combines all the intermediate features.

19. The system of claim 13, wherein the Dirichlet distribution comprises a concentrated Dirichlet distribution over the probability simplex corresponding to confident prediction and comprises a diffused Dirichlet distribution corresponding to uncertain predictions.

20. The system of claim 13, wherein the linear layers consist only of fully connected layers and activation functions.
